(19) United States
(12) Patent Application Publication
(10) Pub. No.: US 2017/0300843 A1
(43) Pub. Date: Oct. 19, 2017

(54) REVENUE GROWTH MANAGEMENT

(71) Applicant: International Business Machines Corporation, Armonk, NY (US)

(72) Inventors: Jean M. Dube, Marlboro, NJ (US); Charles E. Masters, Canton, GA (US)

(21) Appl. No.: 15/097,810

(22) Filed: Apr. 13, 2016

(51) Int. Cl. G06Q 10/06; G06Q 30/02; G06F 17/28

(52) U.S. Cl. CPC G06Q 10/06313; G06F 17/28; G06Q 30/0201

(57) ABSTRACT

In an approach to revenue growth management, one or more computer processors determine one or more best practices for one or more revenue growth processes. The one or more computer processors receive a current maturity level of the one or more revenue growth processes associated with the one or more best practices. The one or more computer processors assess the current maturity level of the one or more revenue growth processes against the one or more associated best practices. The one or more computer processors determine, based, at least in part, on the assessment of the current maturity level of the one or more revenue growth processes, whether improvement is needed in the one or more revenue growth processes to grow revenue. In response to determining improvement is needed in the one or more revenue growth processes, the one or more computer processors determine a project plan to grow revenue.

### BACKGROUND OF THE INVENTION

The present invention relates generally to the field of data processing, and more particularly to systematically improving growth management.

Revenue management is the application of disciplined analytics that predict consumer behavior at the micro-market level and optimize product availability and price to maximize revenue growth. The primary aim of revenue management is selling the right product to the right customer at the right time for the right price. The essence of this discipline is in understanding customers' perception of product value and accurately aligning product prices, placement, and availability with each customer segment. Businesses face important decisions regarding what to sell, when to sell, to whom to sell, and for how much. Revenue management uses data-driven tactics and strategy to answer these questions in order to increase revenue. The discipline of revenue management combines data mining and operations research with strategy, understanding of customer behavior, and partnering with a sales force. Typically, a revenue management practitioner is analytical and detail oriented, yet capable of thinking strategically and managing a relationship with a sales organization. A revenue management process may begin with data collection. Relevant data can be paramount to a revenue management system's capability to provide accurate, actionable information. A revenue management system may collect and store historical data for inventory, prices, demand, and other causal factors. Any data that reflects the details of products offered, their prices, competition, and customer behavior may be collected, stored, and analyzed.

### SUMMARY

Embodiments of the present invention disclose a method, a computer program product, and a system for revenue growth management. The method may include one or more computer processors determining one or more best practices for one or more revenue growth processes. The one or more computer processors receive a current maturity level of the one or more revenue growth processes associated with the one or more best practices. The one or more computer processors assess the current maturity level of the one or more revenue growth processes against the one or more associated best practices. The one or more computer processors determine, based, at least in part, on the assessment of the current maturity level of the one or more revenue growth processes, whether improvement is needed in the one or more revenue growth processes to grow revenue. In response to determining improvement is needed in the one or more revenue growth processes to grow revenue, the one or more computer processors determine a project plan to grow revenue.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a growth management engine, on a server computer within the distributed data processing environment of FIG. 1, for improving revenue growth, in accordance with an embodiment of the present invention;

FIGS. 3A and 3B illustrate examples of a user interface of the growth management engine, on a client computing device within the distributed data processing environment of FIG. 1, in accordance with an embodiment of the present invention; and

FIG. 4 depicts a block diagram of components of the server computer executing the growth management engine within the distributed data processing environment of FIG. 1, in accordance with an embodiment of the present invention.

### DETAILED DESCRIPTION

Regardless of the type of business, enterprises are often seeking to grow revenue as a means to increasing profitability. Revenue growth may be elusive if an enterprise does not utilize a systematic approach. Assessment of best practices and skills, as well as creating useful metrics and engaging stakeholders may be included in a systematic approach. Embodiments of the present invention recognize that improvements to revenue growth management may be achieved by providing a tool that compares a current revenue management process maturity level to a target process, assesses a difference between them, and provides a plan to overcome the difference. Implementation of embodiments of the invention may take a variety of forms, and exemplary implementation details are discussed subsequently with reference to the Figures.

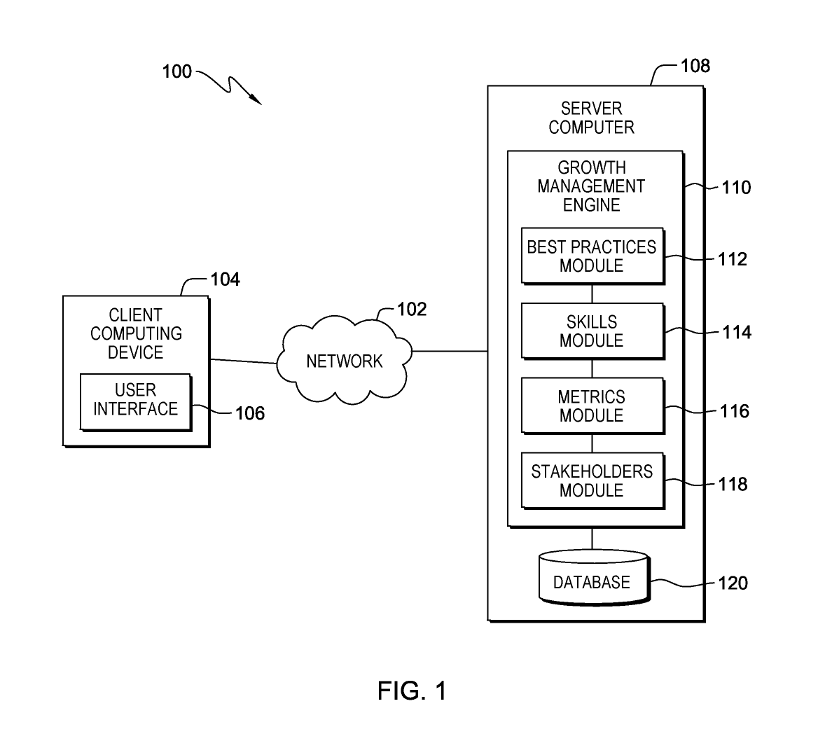

FIG. 1 is a functional block diagram illustrating a distributed data processing environment, generally designated 100, in accordance with one embodiment of the present invention. The term “distributed” as used in this specification describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes client computing device 104 and server computer 108, interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks that are capable of receiving and transmitting data, voice, and/or video signals, including multimedia signals that include voice, data, and video information. In general, network 102 can be any combination of connections and protocols that will support communications between client computing device 104, server computer 108, and other computing devices (not shown) within distributed data processing environment 100.

Client computing device 104 can be a laptop computer, a tablet computer, a smart phone, or any programmable electronic device capable of communicating with various components and devices within distributed data processing environment 100, via network 102. In general, client computing device 104 represents one or more programmable electronic devices or combination of programmable electronic devices capable of executing machine readable program instructions and communicating with other computing devices (not shown) within distributed data processing environment 100 via a network, such as network 102. Client computing device 104 includes user interface 106.

User interface 106 provides an interface between a user of client computing device 104 and server computer 108. In one embodiment, user interface 106 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. In another embodiment, user interface 106 may also be mobile application software that provides an interface between a user of client computing device 104 and server computer 108. Mobile application software, or an “app,” is a computer program designed to run on smart phones, tablet computers and other mobile devices. User interface 106 enables a user of client computing device 104 to access server computer 108 for revenue growth management activities.

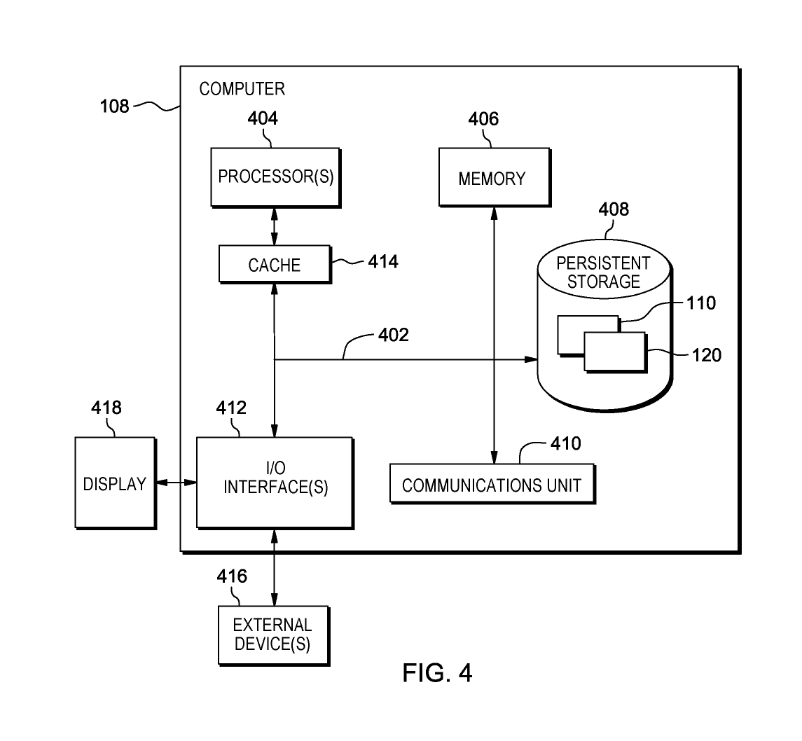

Server computer 108 can be a standalone computing device, a management server, a web server, a mobile computing device, or any other electronic device or computing system capable of receiving, sending, and processing data. In other embodiments, server computer 108 can represent a server computing system utilizing multiple computers as a server system, such as in a cloud computing environment. In another embodiment, server computer 108 can be a laptop computer, a tablet computer, a netbook computer, a personal computer (PC), a desktop computer, a personal digital assistant (PDA), a smart phone, or any programmable electronic device capable of communicating with client computing device 104 and other computing devices (not shown) within distributed data processing environment 100 via network 102. In another embodiment, server computer 108 represents a computing system utilizing clustered computers and components (e.g., database server computers, application server computers, etc.) that act as a single pool of seamless resources when accessed within distributed data processing environment 100. Server computer 108 includes growth management engine 110 and database 120. Server computer 108 may include internal and external hardware components, as depicted and described in further detail with respect to FIG. 4.

Growth management engine 110 establishes a framework for profitable revenue growth to assess the “as is” state of an organization and enables transformation to the “to be” state for growth. Growth management engine 110 enables an organization to systematically drive maturity in the revenue management process and establish continuous improvement. Growth management engine 110 determines the best practices of an organization or enterprise for revenue growth. Growth management engine 110 receives a current maturity level (i.e., “as is” state) of the organization with respect to the best practices and assesses the current maturity level against the best practices. If growth management engine 110 determines improvement is needed for the organization to reach a “to be” state, then growth management engine 110 determines a project plan based on the best practices to help the organization reach a target. In addition to best practices, growth management engine 110 may also assess current skills against skills requirements for inclusion in the project plan. Growth management engine 110 may also determine one or more targets, metrics, or analytics to facilitate measurement of revenue growth. Growth management engine 110 may also determine a list of stakeholders of the project plan to enable a communication plan. In the depicted embodiment, growth management engine 110 resides on server computer 108. In another embodiment, growth management engine 110 may reside on client computing device 104 or another computing device within distributed data processing environment 100 (not shown).

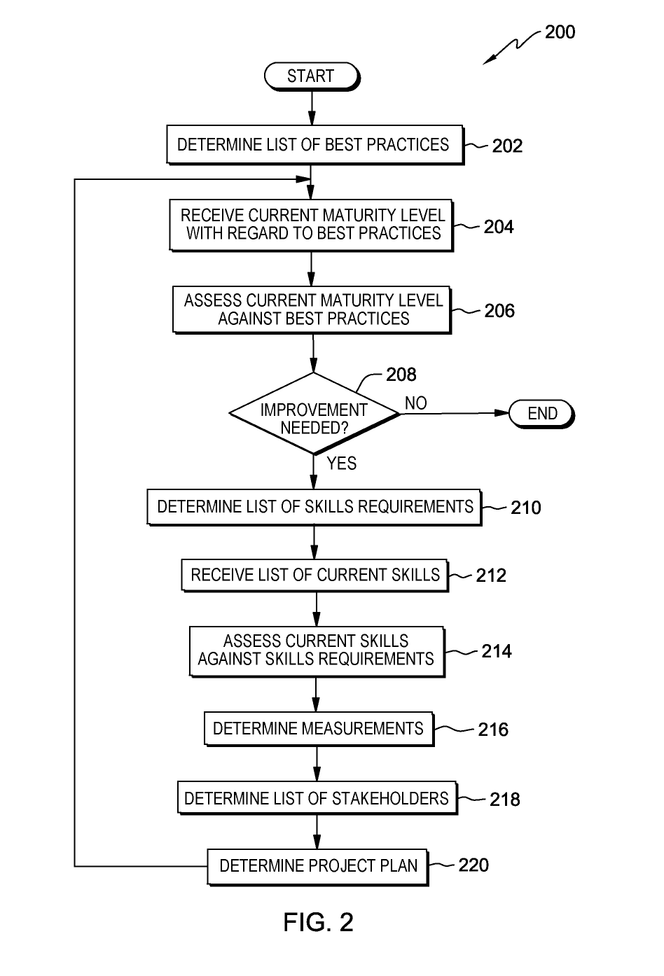

In the depicted embodiment, growth management engine 110 includes four components that perform the various functions of a growth management process, as described above: best practices module 112, skills module 114, metrics module 116, and stakeholders module 118. In another embodiment, growth management engine 110 is a fully integrated tool that includes the functions of the previously listed components, but the components are not individual entities. In a further embodiment, one or more of the four components may be integrated within growth management engine 110. Growth management engine 110 is depicted and described in further detail with respect to FIG. 2.

Best practices module 112 determines a list of best practices of one or more organizations for producing revenue and assesses an organization's current maturity level against the list of best practices. The assessment may include qualitative measurements, quantitative measurements, or both. The assessment is the basis for a project plan for revenue growth.

Skills module 114 facilitates optimization of an organization's staffing for a revenue-producing project. Skills module 114 enables growth management engine 110 to identify a current skill pool, understand where particular skills exist, and develop additional skills such that fluctuations in demand can be accommodated. Skills module 114 may include one or more components. For example, skills module 114 may include market analysis of required skills. In another example, skills module 114 may include job role skill set analysis. In a further example, skills module 114 may include skill development and career roadmap alignment. In yet another example, skills module 114 may include resource and capacity management, including staffing channels.

Metrics module 116 provides a framework for determining measurements such as targets, metrics, and analytics used to measure progress of a revenue management process. Metrics module 116 tracks one or more measurements of revenue, including, but not limited to, health of a pipeline, revenue by quarter, actual and forecasted revenue against a target, extent of demand for skills, and skills availability.

Stakeholders module 118 provides a framework for determining a list of stakeholders of the project. A stakeholder may be a person that is affected by or has an interest in the outcome of a project. Creating a complete list of stakeholders enables communication within an organization that may drive collaboration as well as establishing roles and responsibilities within the organization. In addition, stakeholders may be responsible for driving assessment and improvement of the revenue management process.

Database 120 is a repository for data used by growth management engine 110. In the depicted embodiment, database 120 resides on server computer 108. In another embodiment, database 120 may reside elsewhere within distributed data processing environment 100 provided growth management engine 110 has access to database 120. A database is an organized collection of data. Database 120 can be implemented with any type of storage device capable of storing data and configuration files that can be accessed and utilized by server computer 108, such as a database server, a hard disk drive, or a flash memory. Database 120 stores lists of best practices, skill requirements, and stakeholders. Database 120 may also store results of assessments performed against best practices and skills requirements. In addition, database 120 may also store targets or metrics used to measure revenue. Additionally, database 120 may store historic results of project plans and project metrics from projects performed in the past.

FIG. 2 is flowchart 200, depicting operational steps of growth management engine 110, on server computer 108 within distributed data processing environment 100 of FIG. 1, for improving revenue growth, in accordance with an embodiment of the present invention.

Growth management engine 110 determines a list of best practices (step 202). An organization uses many processes and work products to produce revenue. Growth management engine 110 determines which processes and/or work products have historically produced the best results to create a list of best practices. For example, a best practice may be to create sales collateral for an offering to share with a prospective customer. In one embodiment, growth management engine 110 reviews results of previous project plans and project metrics in database 120 to determine the list of best practices. In another embodiment, growth management engine 110 may receive input from a user of client computing device 104, via user interface 106, to determine the list of best practices. In a further embodiment, growth management engine 110 may determine the list of best practices by using natural language processing (NLP) techniques to access documents, such as emails and presentations, and determine mentions or descriptions of successful processes and/or work products. In an embodiment, growth management engine 110 includes a quantitative or qualitative value with each best practice that represents a target value for that practice. In the depicted embodiment, growth management engine 110 determines the list of best practices via best practices module 112.

Growth management engine 110 receives a current maturity level with regards to best practices (step 204). Growth management engine 110 receives a target value or score for each of the best practices in the list from a user of client computing device 104, via user interface 106, which represents the maturity level of the practice. In one embodiment, growth management engine 110 prompts the user, via user interface 106, to input the current maturity level. In one embodiment, user interface 106 presents the list of best practices as a template in a tabular format with space for input from the user. The score may be either quantitative or qualitative, corresponding to the target value of the best practice. In one embodiment, user interface 106 includes dropdown boxes from which the user can choose a value or score or answer a question. In a quantitative example, if, for sales collateral, user interface 106 lists a best practice as “percentage of offerings with collateral,” then user interface 106 may offer the user a choice of “less than fifty percent” or “greater than fifty percent.” In a qualitative example, if, for sales collateral, user interface 106 lists a best practice as “how effectively does the collateral enable marketing/sales?” then user interface 106 may offer the user a space to respond with a number on a scale from one to five. In the depicted embodiment, growth management engine 110 receives a current maturity level via best practices module 112.

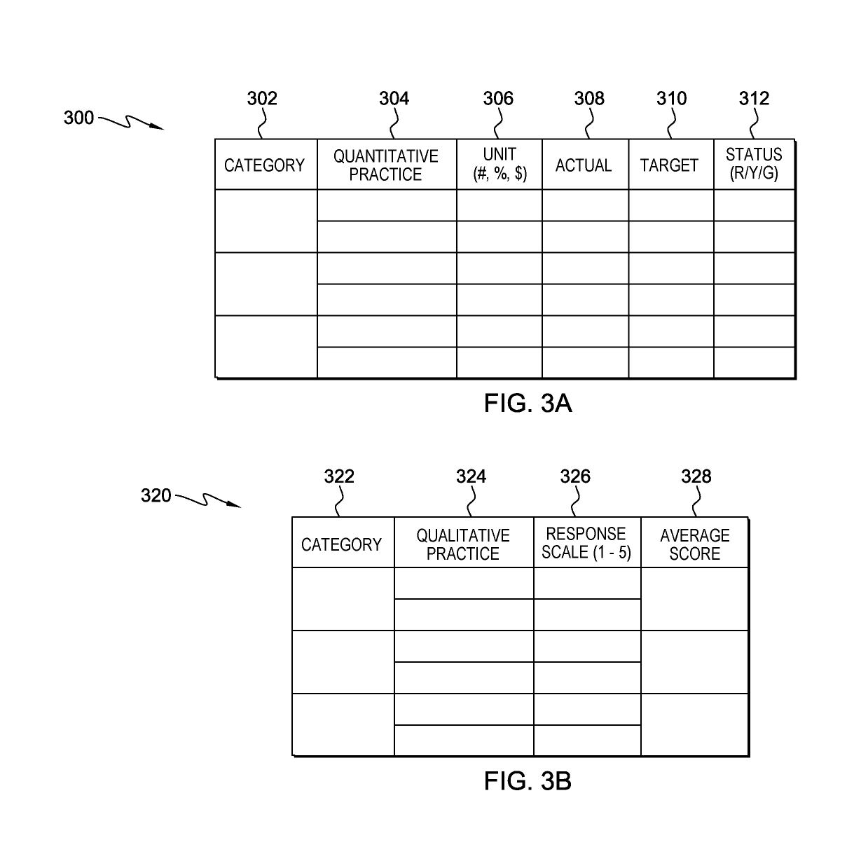

Growth management engine 110 assesses current maturity level against best practices (step 206). Growth management engine 110 compares the received current maturity level score, i.e., the “as is” state, to a target value established for each best practice, i.e., the “to be” state. For example, if the best practice target value for “percentage of offerings with collateral” is “greater than fifty percent,” then growth management engine 110 compares a received score of “less than fifty percent” to the target value. In the depicted embodiment, growth management engine 110 assesses current maturity level against best practices via best practices module 112. The maturity level assessment is depicted and described in further detail with respect to FIGS. 3A and 3B.

Growth management engine 110 determines whether improvement is needed (decision block 208). After assessing a process's current maturity level against a target value of a best practice for that process, growth management engine 110 determines whether the current maturity level meets the best practice target. In one embodiment, growth management engine 110 determines whether the current maturity level matches the best practice target value exactly. In another embodiment, growth management engine 110 determines whether the current maturity level is within a pre-defined threshold of the best practice target value. In one embodiment, growth management engine 110 may assign a color to the maturity level to reflect how close the maturity level is to the best practice target value. For example, if the maturity level is within ten percent of the best practice target value, growth management engine 110 may assign the color “green” to that best practice, while if the maturity level is less than half of the best practice target value, growth management engine 110 may assign the color “red” to that best practice. If growth management engine 110 determines the current maturity level does not meet the best practice target value, then growth management engine 110 determines improvement is needed. In the depicted environment, growth management engine 110 determines improvement is needed via best practices module 112.

If growth management engine 110 determines improvement is needed (“yes” branch, decision block 208), then growth management engine 110 determines a list of skills requirements (step 210). Based on the needed improvements, growth management engine 110 determines a list of skills requirements for one or more persons that will perform one or more tasks to improve the maturity level of the revenue management process. For example, if the project is customer software design, required skills may include, but are not limited to, project management, system architecture, software development, software testing, etc. In one embodiment, growth management engine 110 reviews results of previous project plans and project metrics in database 120 to determine the list of skills requirements. In another embodiment, growth management engine 110 may receive input from a user of client computing device 104, via user interface 106, to determine the list of skills requirements. Each best practice process or work product may require one or more skills for completion. In the depicted embodiment, growth management engine 110 determines the list of skills requirements via skills module 114.

Growth management engine 110 receives a list of current skills (step 212). In one embodiment, growth management engine 110 receives a list of current skills available to work on the project by accessing the organization's personnel records and retrieving a list of skills associated with each member of the organization. In another embodiment, growth management engine 110 may receive a list of current skills from a user of client computing device 104, via user interface 106. In the depicted embodiment, growth management engine 110 receives the list of current skills via skills module 114.

Growth management engine 110 assesses current skills against skills requirements (step 214). Growth management engine 110 compares the list of current skills to the list of skills requirements and determines what skills, if any, are needed on the project to improve the maturity level of the revenue management process. If growth management engine 110 determines skills are needed, then growth management engine 110 creates a list of the needed skills and may store the list in database 120. In the depicted embodiment, growth management engine 110 assesses current skills against skills requirements via skills module 114.

Growth management engine 110 determines measurements (step 216). Based on the best practices, growth management engine 110 determines appropriate targets, metrics, and/or analytics for monitoring progress of the maturity level of the revenue management process. For example, growth management engine 110 may determine a target value for “percentage of offerings with collateral” of seventy five percent, and measurements of progress toward the target may by defined such that a value of less than fifty percent is considered “red,” a value of fifty one to seventy four percent is considered “yellow,” and a seventy five percent or greater is considered “green.” In one embodiment, growth management engine 110 determines measurements by accessing historic project plans and associated measurement charts and selecting similar, appropriate measurements for the current project objectives. In another embodiment, growth management engine 110 may receive input from a user of client computing device 104, via user interface 106, to determine measurements. In a further embodiment, growth management engine 110 may retrieve measurements from one or more of a plurality of sales opportunity software packages known in the art. In the depicted embodiment, growth management engine 110 determines measurements via metrics module 116.

Growth management engine 110 determines a list of stakeholders (step 218). Growth management engine 110 determines a list of one or more personnel that are affected by or have an interest in the outcome of the project. Often, stakeholders hold positions of management or leadership in the organization. In one embodiment, growth management engine 110 determines a list of stakeholders by accessing the organization's personnel records to find a management hierarchy of the project team members. In another embodiment, growth management engine 110 may determine a list of stakeholders by accessing historic project plans and using one or more pre-defined stakeholder lists. In a further embodiment, growth management engine 110 may receive input from a user of client computing device 104, via user interface 106, to determine a list of stakeholders. In the depicted embodiment, growth management engine 110 determines a list of stakeholders via stakeholders module 118.

Growth management engine 110 determines a project plan (step 220). Growth management engine 110 aggregates the maturity level assessment, the skills assessment, the measurements, and the stakeholders determined in previous steps to determine a project plan to improve revenue growth. The project plan may provide details of action items, responsibilities, skills development requirements, target dates, measurements, communication plans, etc. In one embodiment, growth management engine 110 determines a project plan within a project management module included in growth management engine 110 (not shown). In another embodiment, growth management engine 110 may export the appropriate data to one of a plurality of project management software packages known in the art. In yet another embodiment, a user of client computing device 104 may receive the aggregated data from growth management engine 110, via user interface 106, and input the data into one of a plurality of project management software packages known in the art. Once growth management engine 110 determines the project plan, growth management engine 110 provides the project plan to a user, such as a project manager, a project team, or an enterprise that can implement the plan in an effort to transform to the “to be” state for revenue growth.

After growth management engine 110 determines a project plan, growth management engine 110 returns to step 204 to receive a current maturity level and proceed through the remainder of the steps again, such that growth management engine 110 systematically drives continuous improvement in revenue growth, with the “to be” state as a target, rather than relying on a user continue the process. In one embodiment, growth management engine 110 may return to step 204 after a pre-defined time interval to enable measurement of a projects' progress toward one or more targets by prompting a user, via user interface 106, to input the current maturity level with regards to best practices, i.e., the “as is” state. In another embodiment, growth management engine 110 may only return to step 204 at the end of a project. In a further embodiment, growth management engine 110 may return to step 204 upon initiation by a user of client computing device 104, via user interface 106. If growth management engine 110 determines improvement is not needed (“no” branch, decision block 208), then growth management engine 110 ends.

In various embodiments, one or more of the steps described above may be optional. For example, growth management engine 110 may omit steps 210 through 214 if an assessment of skills is not required. In another example, growth management engine 110 may omit step 216 if project measurements are not needed. In a further example, growth management engine 110 may omit step 218 if the organization does not need a defined list of stakeholders.

FIGS. 3A and 3B illustrate tables 300 and 320 as examples of user interface 106 of growth management engine 110, on client computing device 104 within distributed data processing environment 100 of FIG. 1, in accordance with an embodiment of the present invention.

FIG. 3A depicts table 300 of user interface 106 for assessment of quantitative practices of revenue growth. Column 302 lists categories that growth management engine 110 has identified as areas of concern. For example, categories may include, but are not limited to, offerings, sales, pipeline, or solution. Column 304 lists quantitative practices that growth management engine 110 monitors. There may be more than one quantitative practice per category, as is shown in column 304. Examples of quantitative practices may include, but are not limited to, percentage of offerings with collateral, number of leads in a sales funnel, or value of contracts signed. Column 306 lists the units in which the practice is measured. For example, practices may be measured as a number, a percentage, or a dollar amount. Column 308 lists actual results of the practice at the time that growth management engine 110 receives data associated with the maturity level of the project, as described with respect to step 204 in FIG. 2. Column 310 lists best practice target values for each of the practices. Column 312 lists the results of the assessment of the current maturity level versus the best practices, as discussed with respect to step 206 in FIG. 2. In the depicted example, the results of the assessment are shown as a status that includes colors, i.e., red, yellow, and green. The status is the comparison of the actual value to the target value.

FIG. 3B depicts table 320 of user interface 106 for assessment of qualitative practices of revenue growth. Column 322 lists categories that growth management engine 110 has identified as areas of concern. For example, categories may include, but are not limited to, offerings, sales, pipeline, or solution. Column 324 lists qualitative practices that growth management engine 110 monitors. There may be more than one qualitative practice per category, as is shown in column 324. Examples of qualitative practices may include, but are not limited to, effectiveness of a communication plan, confidence in pipeline, or competitiveness of an offering. Column 326 lists a response to the qualitative practices. In the depicted example, the response is on a numeric scale from one to five. Growth management engine 110 may display the assessment of the response by showing a color. For example, a response of three or below may be shown as red, a response of four may be shown as yellow, and a response of five may be shown as green. Column 328 lists the average score for the responses in a category. Growth management engine 110 may display the average score as the numeric average of the numbers in column 326. Growth management engine 110 may also display the average score by showing a color, as discussed with respect to the response to the quantitative practice.

FIG. 4 depicts a block diagram of components of server computer 108 within distributed data processing environment 100 of FIG. 1, in accordance with an embodiment of the present invention. It should be appreciated that FIG. 4 provides only an illustration of one implementation and does not imply any limitations with regard to the environments in which different embodiments can be implemented. Many modifications to the depicted environment can be made.

Server computer 108 can include processor(s) 404, cache 414, memory 406, persistent storage 408, communications unit 410, input/output (I/O) interface(s) 412 and communications fabric 402. Communications fabric 402 provides communications between cache 414, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM). In general, memory 406 can include any suitable volatile or non-volatile computer readable storage media. Cache 414 is a fast memory that enhances the performance of processor(s) 404 by holding recently accessed data, and data near recently accessed data, from memory 406.

Program instructions and data used to practice embodiments of the present invention, e.g., growth management engine 110 and database 120 can be stored in persistent storage 408 for execution and/or access by one or more of the respective processor(s) 404 of server computer 108 via memory 406. In this embodiment, persistent storage 408 includes a magnetic hard disk drive. Alternatively, or in addition to a magnetic hard disk drive, persistent storage 408 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices, including resources of client computing device 104. In these examples, communications unit 410 includes one or more network interface cards. Communications unit 410 may provide communications through the use of either or both physical and wireless communications links. Growth management engine 110 and database 120 may be downloaded to persistent storage 408 of server computer 108 through communications unit 410.

I/O interface(s) 412 allows for input and output of data with other devices that may be connected to server computer 108. For example, I/O interface(s) 412 may provide a connection to external device(s) 416 such as a keyboard, a keypad, a touch screen, a microphone, a digital camera, and/or some other suitable input device. External device(s) 416 can also include portable computer readable storage media such as, for example, thumb drives, portable optical or magnetic disks, and memory cards. Software and data used to practice embodiments of the present invention, e.g., growth management engine 110 and database 120 on server computer 108, can be stored on such portable computer readable storage media and can be loaded onto persistent storage 408 via I/O interface(s) 412. I/O interface(s) 412 also connect to a display 418.

Display 418 provides a mechanism to display data to a user and may be, for example, a computer monitor. Display 418 can also function as a touchscreen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for revenue growth management, the method comprising:
determining, by one or more computer processors, one or more best practices for one or more revenue growth processes;
receiving, by the one or more computer processors, a current maturity level of the one or more revenue growth processes associated with the one or more best practices;
assessing, by the one or more computer processors, the current maturity level of the one or more revenue growth processes against the one or more associated best practices;
determining, based, at least in part, on the assessment of the current maturity level of the one or more revenue growth processes, whether improvement is needed in the one or more revenue growth processes to grow revenue; and
responsive to determining improvement is needed in the one or more revenue growth processes, determining, by the one or more computer processors, a project plan to grow revenue.

2. The method of claim 1, further comprising:
determining, by the one or more computer processors, one or more skills required for the project plan;
receiving, by the one or more computer processors, one or more current skills available for the project plan;
assessing, by the one or more computer processors, the one or more current skills against the one or more skills required; and
determining, by the one or more computer processors, whether one or more skills are needed for the project plan.

3. The method of claim 1, further comprising:
responsive to determining a project plan to grow revenue, providing, by the one or more computer processors, the project plan to a user; and
prompting, by the one or more computer processors, the user, after a pre-defined time interval, to input a current maturity level of the one or more revenue growth processes associated with the one or more best practices.

4. The method of claim 1, further comprising determining, by the one or more computer processors, one or more measurements for the project plan, wherein the one or more measurements are at least one of quantitative or qualitative.

5. The method of claim 4, wherein the one or more measurements include at least one of:
a target value, a target date, a metric, one or more analytics, a health of a pipeline, a revenue by quarter, an actual revenue against a target, a forecasted revenue against a target, an extent of demand for skills, or a skills availability.

6. The method of claim 1, further comprising determining, by the one or more computer processors, one or more stakeholders of the project plan.

7. The method of claim 1, wherein the project plan includes at least one of: an action item, a responsibility, a skill development requirement, a target date, a measurement, or a communication plan.

8. The method of claim 1, wherein determining one or more best practices for one or more revenue growth processes further comprises determining, by the one or more computer processors, one or more successful processes using natural language processing techniques to access one or more documents that include at least a description of the one or more successful processes.

9. A computer program product for revenue growth management, the computer program product comprising:
one or more computer readable storage devices and program instructions stored on the one or more computer readable storage devices, the stored program instructions comprising:
program instructions to determine one or more best practices for one or more revenue growth processes;
program instructions to receive a current maturity level of the one or more revenue growth processes associated with the one or more best practices;
program instructions to assess the current maturity level of the one or more revenue growth processes against the one or more associated best practices;
program instructions to determine, based, at least in part, on the assessment of the current maturity level of the one or more revenue growth processes, whether improvement is needed in the one or more revenue growth processes to grow revenue; and
responsive to determining improvement is needed in the one or more revenue growth processes, program instructions to determine a project plan to grow revenue.

10. The computer program product of claim 9, the stored program instructions further comprising:
program instructions to determine one or more skills required for the project plan;
program instructions to receive one or more current skills available for the project plan;
program instructions to assess the one or more current skills against the one or more skills required; and
program instructions to determine whether one or more skills are needed for the project plan.

11. The computer program product of claim 9, the stored program instructions further comprising:
responsive to determining a project plan to grow revenue, program instructions to provide the project plan to a user; and
program instructions to prompt the user, after a pre-defined time interval, to input a current maturity level of the one or more revenue growth processes associated with the one or more best practices.

12. The computer program product of claim 9, the stored program instructions further comprising program instructions to determine one or more measurements for the project plan, wherein the one or more measurements are at least one of quantitative or qualitative.

13. The computer program product of claim 9, the stored program instructions further comprising program instructions to determine one or more stakeholders of the project plan.

14. The computer program product of claim 9, wherein the program instructions to determine one or more best practices for one or more revenue growth processes comprise program instructions to determine one or more successful processes using natural language processing techniques to access one or more documents that include at least a description of the one or more successful processes.

15. A computer system for revenue growth management, the computer system comprising:
one or more computer processors;
one or more computer readable storage device;
program instructions stored on the one or more computer readable storage devices for execution by at least one of the one or more computer processors, the stored program instructions comprising:
program instructions to determine one or more best practices for one or more revenue growth processes;
program instructions to receive a current maturity level of the one or more revenue growth processes associated with the one or more best practices;
program instructions to assess the current maturity level of the one or more revenue growth processes against the one or more associated best practices;
program instructions to determine, based, at least in part, on the assessment of the current maturity level of the one or more revenue growth processes, whether improvement is needed in the one or more revenue growth processes to grow revenue; and
responsive to determining improvement is needed in the one or more revenue growth processes, program instructions to determine a project plan to grow revenue.

16. The computer system of claim 15, the stored program instructions further comprising:
program instructions to determine one or more skills required for the project plan;
program instructions to receive one or more current skills available for the project plan;
program instructions to assess the one or more current skills against the one or more skills required; and
program instructions to determine whether one or more skills are needed for the project plan.

17. The computer system of claim 15, the stored program instructions further comprising:
responsive to determining a project plan to grow revenue, program instructions to provide the project plan to a user; and
program instructions to prompt the user, after a pre-defined time interval, to input a current maturity level of the one or more revenue growth processes associated with the one or more best practices.

18. The computer system of claim 15, the stored program instructions further comprising program instructions to determine one or more measurements for the project plan, wherein the one or more measurements are at least one of quantitative or qualitative.

19. The computer system of claim 15, the stored program instructions further comprising program instructions to determine one or more stakeholders of the project plan.

20. The computer system of claim 15, wherein the program instructions to determine one or more best practices for one or more revenue growth processes comprise program instructions to determine one or more successful processes using natural language processing techniques to access one or more documents that include at least a description of the one or more successful processes.
